(19) United States
(12) Patent Application Publication
(10) Pub. No.: US 2015/0324818 A1
(43) Pub. Date: Nov. 12, 2015

(54) Long-Term Flow Assurance In A Transportation System

(71) Applicants: Jason W. Lachance, Magnolia, TX (US); Jiyong Cai, Katy, TX (US); Charles J. Mart, Baton Rouge, LA (US)

(72) Inventors: Jason W. Lachance, Magnolia, TX (US); Jiyong Cai, Katy, TX (US); Charles J. Mart, Baton Rouge, LA (US)

(21) Appl. No.: 14/704,527

(22) Filed: May 5, 2015

Related U.S. Application Data
(60) Provisional application No. 61/990,798, filed on May 9, 2014.
(60) Provisional application No. 62/134,848, filed on Mar. 18, 2015.

(51) Int. Cl. G06Q 30/02

(52) U.S. Cl. CPC G06Q 30/0202; G06Q 50/30

(57) ABSTRACT

A method and system for long-term flow assurance is provided. Data is periodically acquired from multiple transportation systems each having a transportation structure such as a pipeline, and a transported material such as hydrocarbons or oil and gas. The data is stored in a central location. A global predictive flow model is maintained based on the data acquired from the multiple transportation systems. A data set of a transportation system of the multiple transportation systems is analyzed via the global predictive flow model to determine a flow assurance issue of the transportation system.

### CROSS REFERENCE TO RELATED APPLICATIONS

This application claims the priority benefit of both U.S. patent application No. 61/990,798 filed May 9, 2014 entitled LONG-TERM FLOW ASSURANCE IN A TRANSPORTATION SYSTEM and U.S. patent application No. 62/134,848 filed Mar. 18, 2015 entitled LONG-TERM FLOW ASSURANCE IN A TRANSPORTATION SYSTEM, the entirety of which is incorporated by reference herein.

### FIELD

The present techniques provide for flow assurance related to the transportation of production fluids such as oil and natural gas. More specifically, the techniques can be utilized to help maintain the continuous flow of a transported material.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Flow assurance refers to ensuring the flow of production fluids from a point of origin to a point of sale is maintained in an economically viable manner. Periodic interruptions in production due to issues with flow assurance may have serious financial consequences, especially if assets such as production pipelines are damaged, or production flow is lost or reduced, and so on. Because flow assurance problems are inherently a function of time, as problems arise when certain conditions are present in a system for an extended period, flow assurance has typically been a reactive issue. Commonly, flow assurance engineers are called upon to troubleshoot problems when the flow line is already or nearly plugged, or if flow conditions are currently upsetting the overall system.

The following references use online pipeline management systems to monitor potential pipeline issues such as hydrate formation or potential multiphase hydraulic issues. U.S. Patent Application No. 2011/0224835 describes an integrated flow assurance system. The system is comprised of a plurality of flow assurance devices, including a platform device to interface with the plurality of flow assurance devices to enable a single point of data entry for the flow assurance devices of the system.

U.S. Pat. No. 7,171,316 describes a method for producing images of reservoir boundaries. The method includes making a forecast as to whether a flow assurance curve will intersect with an operating curve of a fluid, and personnel may be alerted in an attempt to prevent hydrates from forming in a pipe carrying the fluid.

U.S. Patent Application No. 2011/0127032 describes a method for monitoring hydrocarbon production. The method monitors a fluid flow in a flow line using sensors located along the flow line, and is used to indicate the flow conditions within the flow line.

These references are directed toward online monitoring systems that focus primarily on indications like pressure drops and whether hydrate formation in a pipeline threatens to decrease fluid flow. These references are focused on using the monitored data to implement an immediate response in online control. For example, when a substantial change in pressure has been indicated, then flow rate within the line might be automatically adjusted, or when fluid in the pipeline is in the hydrate formation range, then flow of an additive, such as methanol, can be set to increase.

### SUMMARY

An exemplary embodiment provides a method for long-term flow assurance, including periodically acquiring data from multiple transportation systems each having a transportation structure and a transported material. The method includes storing the data in a central location. The method includes maintaining a global predictive flow model based on the data acquired from the multiple transportation systems. The method also includes analyzing via the global predictive flow model a data set of a transportation system of the multiple transportation systems to determine a flow assurance issue of the transportation system.

Another exemplary embodiment provides a method of producing oil and gas, including acquiring first data related to a first pipeline transporting oil and gas. The method includes acquiring second data related to a second pipeline transporting oil and gas. The method includes storing the first data and the second data in a central location. The method includes constructing a global predictive flow model correlative with the first data and the second data. The method also includes comparing subsequent data related to the first pipeline to the first data via the global predictive flow model to determine a flow assurance issue of the first pipeline.

Another exemplary embodiment provides a flow assurance system, including a central database to store data acquired from multiple transportation systems that each convey a respective transported material comprising hydrocarbon. The system also includes a global server configured to acquire the data from the multiple transportation systems and store the data to the central database. The global server is configured to maintain a global predictive flow model correlative with the data acquired from the multiple transportation systems. The global server is also configured to analyze via the global predictive flow model a data set of a transportation system of the multiple transportation systems to determine a flow assurance issue of the transportation system.

### DESCRIPTION OF THE DRAWINGS

The advantages of the present techniques are better understood by referring to the following detailed description and the attached drawings, in which:

FIG. 1 is a block diagram of a transportation and flow assurance system, and associated workflow;

FIG. 2 is a block diagram of a flow assurance system;

FIG. 3 is a process flow diagram of a method of assuring the flow of a transported material;

FIG. 4 is a block diagram of a flow assurance system;

FIG. 5 is a block diagram of an exemplary method of how conditions of a transported fluid can be monitored and updated over time, such as with respect to the fluid file repository of FIG. 4;

FIG. 6 is a block diagram an exemplary method of how conditions related to a transportation structure can be monitored and updated over time, such as with respect to the flow line repository of FIG. 4;

FIG. 7 is a block diagram of an exemplary control system that may be used to implement flow assurance techniques;

FIG. 8 is a diagram of a pipeline system that also illustrates a control system operative to maintain the flow of fluid within the pipeline system; and

FIG. 9 is another diagram illustrating a comprehensive work flow in which global field data can be monitored and notifications made to indicate potential flow assurance issues.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

As used herein, “flow assurance” means the function of controlling the production flow from the initial sites such as reservoirs through the wells and facilities to a point of transfer. The purpose of this function is to ensure the planned production is realized efficiently, economically, and within the safety and operational boundaries of all transport equipment.

As used herein, “flow assurance tools” can include a variety of proprietary software that is configured to perform a particular system analysis that may be related to assuring continued flow within a system. These flow assurance tools can include tools that are used to predict pressure drops, temperature profiles, flow rates, and other variables related to a transportation system and a transported structure in respect to typical flow assurance issues, such as wax deposition/wax gelling, hydrate transportation, sand/solid deposition/transport, inorganic/organic scale transport, and drag reduce additive (DRA) efficiency.

A “feed file” includes the current hydraulic and thermodynamic properties of a fluid within a flow line. The feed file can also include a pressure, volume, temperature (PVT) thermodynamic simulator that compiles and runs calculations on thermodynamic state variables, and determines a current profile for a fluid flowing inside a transportation structure. Such feed files are essential to updating and running subsequent hydraulic simulators, and other flow assurance or solids and chemical management tools.

As used herein, a “repository” is understood to comprise a centralized computer database utilized for continually managing and updating overall system data that are pertinent for analyzing flow assurance issues. A fluid file repository may be positioned at a central location, and may be configured to regularly update and maintain pressure, volume, and temperature files, for example. A flow line repository is at a central location that updates and maintains field layout diagrams, piping diagrams, and production well status, for example. The data stored, updated, and/or generated by a repository is subsequently utilized by feed file monitors and other flow assurance software and tools, in order, for example, to supply and create the most accurate and up-to-date system properties.

A “hydraulic simulator” is a program that utilizes various hydraulic flow models and dynamic simulations based on feed files to produce up-to-date flow files related to a transportation system. The hydraulic simulators can account for changes in system flow, temperature, volume, pressure, and system flow line geometries, for example. Output from the hydraulic simulator is subsequently analyzed by flow assurance tools in a flow assurance database, and discrepancies that have promulgated over time can potentially be flagged as an issue of concern or opportunity for personnel to analyze.

As used herein, the term “global” or “globally” may be understood as comprising a plurality of geographic locations or geographic areas, for example, systems and/or components in geographically remote or geographically disparate cities, states, countries, and/or continents. The geographic location(s) or geographic area(s) comprised within the term “global” or “globally” may include two or more areas separated by between 100-22,000 kilometers (km), 1,000-22,000 km, 10,000-22,000 km, 15,000-22,000 km, 100-15,000 km, 100-10,000 km, 100-1,000 km, 1,000-15,000 km, 1,000-10,000 km, and/or 10,000-15,000 km. The separation and/or identification of geographic locations or geographic areas related thereto may be based on geographic terrain (e.g., topology), geographic features (e.g., water bodies, waterways, oil reserves, etc.), political boundaries, economic boundaries, or other criteria.

Embodiments of the present techniques facilitate long-term flow assurance, and may flag certain workflow steps that may be improved. Particular embodiments may include an active self-updating system for flow assurance, including to actively update fluid files and flow line properties files that change over time. The techniques may compare substantially continuous or periodic measurements and calculations to determine whether flow could be affected unfavorably or favorably. Examples optimize or promote flow line mechanics using solids management and fluid dynamics optimization or considerations, for instance. Flow assurance curves may be employed, including in the context of a continued or periodic update of data and files as fluid and system conditions change.

Some embodiments may couple hydraulics with potential flow assurance issues, for example, sand and hydrate accumulation, and inclusion of chemicals such as drag reducing agents may also be considered. Hydraulic analysis and models may be combined with hydrodynamic or flow assurance analysis and models related to sand and hydrate accumulation, for example. In certain embodiments, a comprehensive predictive flow model incorporating these features may be constructed and employed. Comprehensive models and underlying specific models may be employed in production systems, transportation systems, workflow systems, and flow assurance systems. In examples, the model or models are employed at a global or central location to analyze data collected from geographically-dispersed local sites, meaning sites geographically remote from each other on a global scale.

In general, embodiments provide for a broad geographic nature of data capture, and thus a centralized data capture. Indeed, data may be collected from multiple locations and transportation systems (e.g., pipelines), including from multiple vendors. Further, predictive modeling capabilities may be implemented on a data set from a plurality of pipelines, including on a global scale. The actual data monitored may be compared versus a model to determine a problem condition or opportunity, such as those discussed herein. The global predictive flow model may accommodate actual data captured, as well as real and hypothetical data provided from a local site (e.g., operator or engineer) the local site desires to evaluate.

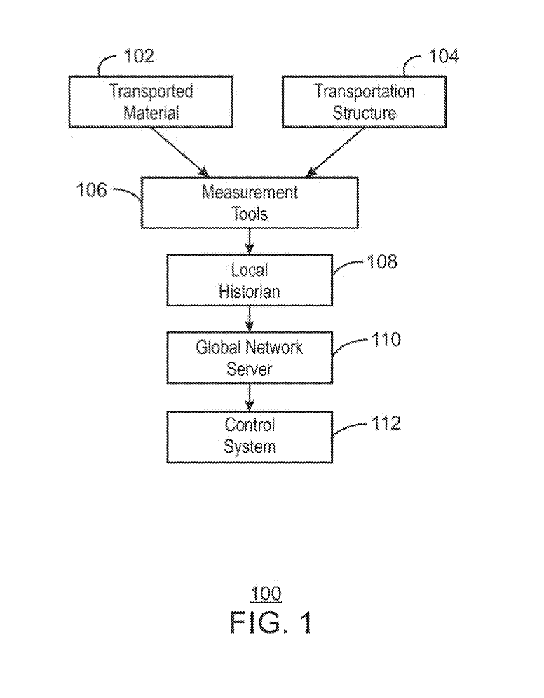

FIG. 1 is a block diagram showing a workflow for a transportation system 100 incorporating flow assurance. The transportation system 100 via its flow assurance system generally tracks the transportation of a transported material 102. In an exemplary embodiment, the transported material 102 is a flowable hydrocarbon production fluid, such as oil or natural gas, water, brine, solid impurities, or a mixture thereof. The transported material 102 is moved from one location to another via a transportation structure 104 of the transportation system 100. In an exemplary embodiment, the transportation structure 104 includes a flow line or conduit such as a pipeline that starts at or near a production well, and is configured to flow production fluids from the well to a production facility or some other point of sale. The flow assurance system of the transportation system 100 includes measurement tools 106 that acquire data related to the transportation system 100 including the transported material 102 and the transportation structure 104. The measurement tools 106 are configured to send data to a data storage system such as local historian 108. A historian is a database coupled to a control network that can be used to store and record process data and structural data to a storage device. The local historian 108 may be configured to store the received data in a database, hard drive, or other means of digital storage. The local historian 108 is connected to a global network server 110. The data may be forwarded from the local historian 108 to a central historian via the global network server 110 (or as the central historian as a component of the global network be sever 110). The global network server 110 is configured to collaborate and analyze data acquired from the transportation system 100 on periodic intervals, for example.

The global network server 110 or an associated global information system may acquire data from several local historians 108 of several respective transportation systems 100. The various transportations systems 100 may be adjacent systems and/or geographically-dispersed systems located worldwide. Data relating to a transported material 102 or transportation structure 104 can be acquired from the field, for example, globally. Subsequent notifications can be made at the global network server 110 to a local control system 112, such as a process control system of a transportation system 100, if the data indicate potential flow assurance issues, for instance. The workflow, or sequence of interconnected steps which include the complex data analysis, may also be used to identify areas of potential flow assurance research, and strategies for optimization or increased flow assurance and that reduce uncertainty in particular situations. While an analysis may be made for a specific system 100, the analysis may benefit from correlations derived globally from several systems 100. When the data acquired by the measurement tools 106 are analyzed using flow assurance techniques, such as those discussed herein, the global network server 110 via the control system 112 may alert personnel, such as pipeline operators, pipeline engineers, or flow assurance engineers, among others, of potential issues that have been flagged with respect to the production process. The global network server 110 or global information system may be in communication with several control systems 112 of several respective systems 100 located in a given region or around the world. In an exemplary embodiment, the control system 112 is a distributed control system (DCS) or programmable logic controller (PLC) associated with a pipeline control room and operations. The control system 112 can be configured to monitor and make adjustments in the transportation system 100, including with respect to the transported structure 104 having the transported material 102, automatically upon the occurrence of some predefined condition. The control system 112 can alert personnel of potential issues or strategies for optimization or increased flow assurance in the system 100. Thus, the personnel may generally be in a position to better further monitor the transportation system, make further inquiries, and propose adjustments, accordingly.

The block diagram of FIG. 1 is not intended to indicate that the system 100 is to include all of the components shown in FIG. 1. Further, any number of additional components may be included within the transportation system 100, depending on the details of the specific implementation. For example, the transportation system 100 can be designed to achieve desired flow assurance in a logistical chain that includes rail cars, trucks, tanker ships or other freight vehicles, with or without an extensive production pipeline.

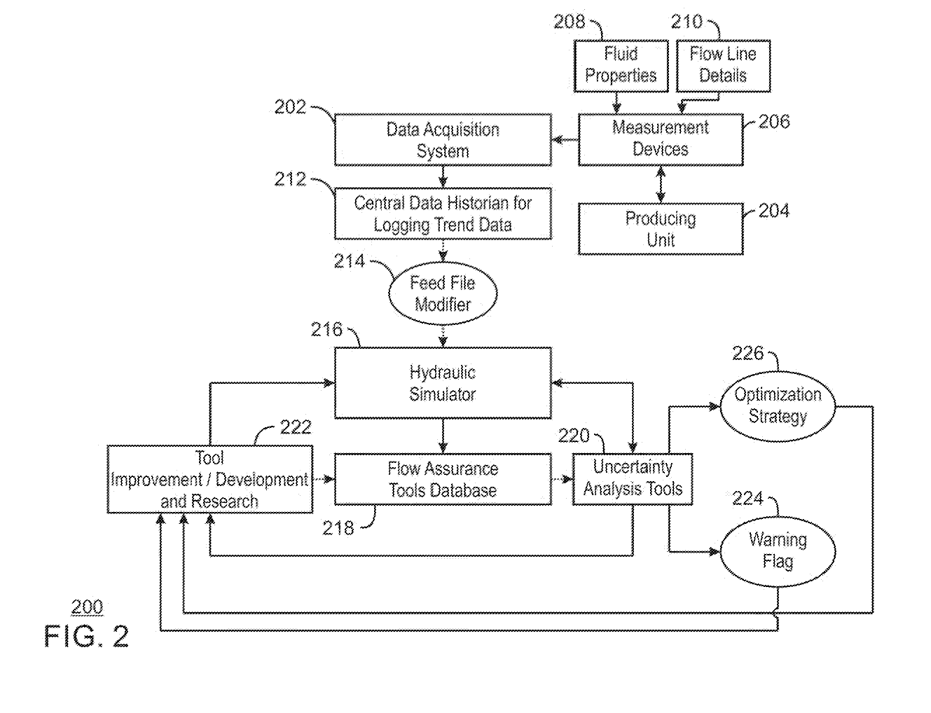

FIG. 2 is a block diagram that illustrates a flow assurance system 200. A data acquisition system 202 is connected to a producing unit 204 through various measurement devices 206. In an exemplary embodiment, the producing unit 204 includes an oil and gas well and pipeline system. Connected to the producing unit 204 are measurement devices 206 that are configured to measure certain properties related to the producing unit 204. Exemplary measurement devices 206 include pressure transducers, flow meters, temperature probes, phase level detectors, sensors for measuring concentrations and densities, and other sensors capable of making a physical measurement. The measurement devices 206 communicate data about a producing unit 204 to a data acquisition system 202. Fluid properties 208, including volumetric flow rate, density, temperature, pressure, concentration data, as well as flow line details 210, including piping conditions, terrain geometries around the flow line, and other details can be measured by measurement devices 206.

The data acquired from the measurement devices 206 by the data acquisition system 202 is sent to a central data historian 212. The central data historian 212 logs the trend data in a storage device, such as a storage database, a hard drive disk, or a flash memory device, for example. The trend data is sent to a feed file modifier 214. The feed file modifier 214 tags and interprets the data stored at the central historian 212, and inputs data including pressure, temperature and volume properties of the transported fluid to a hydraulic simulator 216.

The hydraulic simulator 216 is configured to update fluid properties as well as the pipeline profile of the flow assurance system 200. In an exemplary embodiment, the hydraulic simulator 216 sends updated feed file properties to a flow assurance tools database 218 that uses, for example, solids and chemical management tools or other flow assurance tools, coupled with a hydraulic simulator to predict pressure drops, temperature profiles, and flow rates within the system 200. The data that is interpreted at the flow assurance tools database 218 is further processed by an uncertainty analysis tool 220.

The uncertainty analysis tool 220 is a statistical uncertainty tool that will analyze the most important factors affecting the predictions, and help model and account for uncertainty. This uncertainty data will be used for tool improvement and research and development 222. In an exemplary embodiment, the data are utilized for updating the base hydrodynamic model, if necessary. Alternatively, the data can be fed, for example, to flow assurance engineers to update and perform further research on the models. The improved analyzed data can be reintroduced into the hydraulic simulator 216, which can more effectively interpret recent data from the field that has been updated by the feed file monitor 214.

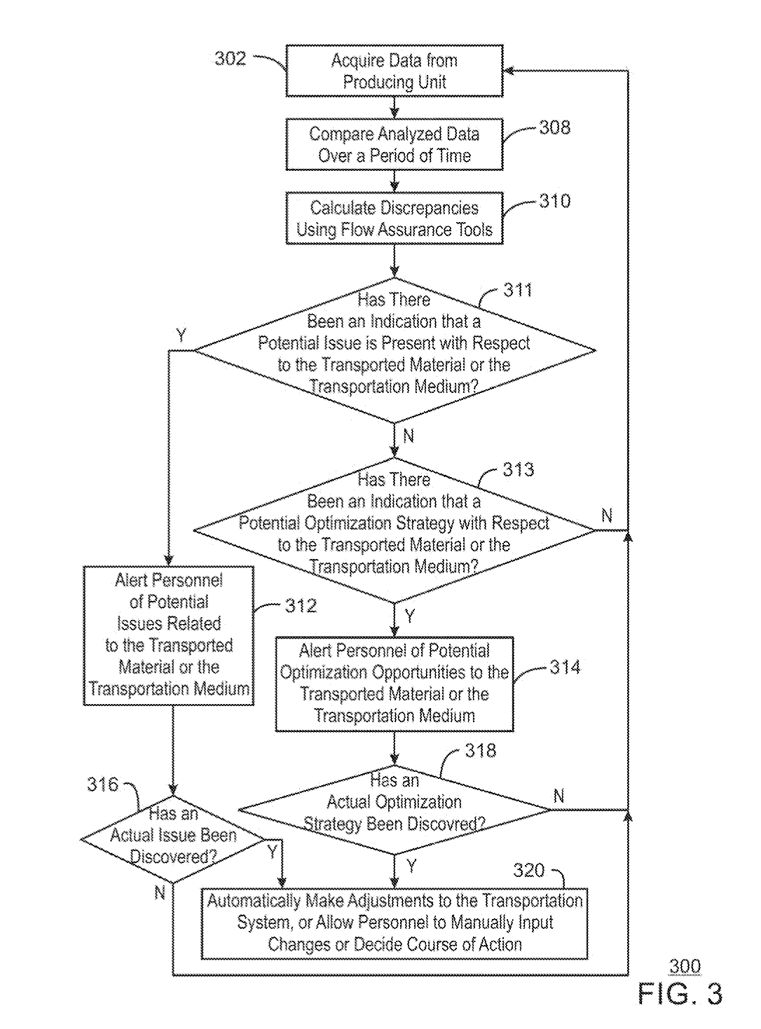

As a result of these various tools working together in the flow assurance system 200, warning flags 224 related to fluid properties 208 or flow line details 210 may be provided. These warning flags 224 are communicated to personnel who then may make take action to enhance or maintain the flow of the transported material. In addition to potential problems, the flow assurance system 200 may be configured to identify opportunities to implement an optimization strategy 226. Potential issues that may be prevented by timely and appropriate action can include, for example, pigging a line before excessive fouling significantly impedes flow, or inhibiting, to some extent, formation of hydrates or waxes in a flow line. The flow assurance system 200, and the method 300 of FIG. 3 below, monitor the work flow in which data from the field can be analyzed and subsequent notifications taken if the data indicates any potential flow assurance issues. The work flow will also be used to identify areas of potential flow assurance research areas to reduce uncertainty in particular situations.

FIG. 3 is a process flow diagram illustrating a method of assuring the flow of a transported material is maintained. The method 300 begins at block 302 by acquiring data from a particular producing unit, for example, a deep sea oil and gas production well. The data that is acquired can be related to the fluid that is transported from the producing unit. The acquired data can also be related to the transportation structure, for example, a pipeline system that transports the transported material. The acquired data related to the transportation structure and transported material may be stored locally such as in a local historian, such as the local historian discussed with respect to FIG. 1. Some analysis of the data may be performed locally. The data and any analysis is communication and stored to a global or central historian, such as the central historian 212 discussed with respect to FIG. 2. The central historian or database and associated global information and analysis system incorporates a global pipeline data analysis tool that would bring in desired field data on a predetermined interval for various fields. Pertinent data are tagged as data tags, and these data tags can be coupled with the respective profile for the transportation structure, for example, a pipeline profile, and fluid property data, for example, data acquired from proprietary analysis tools and other PVT software.

At block 308, analyzed data that has been compiled at the central location over time is compared to data that has been more recently analyzed by the flow assurance modeling tools. Profiles about the fluid that is fed in the pipeline may be generated and continually updated. The data are stored in the centrally located database and may be used in conjunction with industry standard flow simulators, or other hydraulic simulators to predict pressure drops, temperature profiles, flow rates, and other system properties. These outputs are used by the data comparison tool at block 308 for understanding the uncertainty in the particular analysis and then compared to the data from the field. At block 310 discrepancies are calculated using flow assurance tools. At block 311, a decision is made as to whether there has been an indication that a potential issue is present with respect to the transported material or the transportation medium. If the data from the field are matching the predictions, within preselected limits, then the cycle continues. If there has been an indication of a potential issue, then at block 312 personnel are alerted of potential issues related to the transported material or the transportation structure. These issues can range from major to insignificant, from immediately pertinent to being low priority in the overall flow assurance system.

If there has been no indication of an issue at block 311, then a decision is made at block 313 whether there has been an indication that a potential optimization strategy is present with respect to the transported material or the transportation medium. If there has not been any indication, then the method 300 starts again at block 302. If there has been an indication at block 313, then the method 300 continues to block 314, where personnel are alerted of potential optimization opportunities related to the transported material or the transportation structure. This method 300 permits personnel to be proactive in preventing escalation of a particular flow assurance issue, or in implementing a particular strategy for optimizing the rate of flow in a pipeline.

If, at block 316, an actual issue has been determined, or if, at block 318 an actual optimization opportunity is available, then, at block 320, adjustments to the transportation system can automatically be made, or personnel can manually input changes or decide an appropriate course of action. If there is no issue determined at 316, or no potential for optimization realized at 318, or after desired changes are made at block 320, the method 300 is complete, having assured that flow of the transported material is maintained. The method 300 can be implemented continuously in the manner described herein. In an exemplary embodiment, flow assurance is maintained from the location of the producing unit to a point of sale located somewhere downstream.

This method 300 can be implemented in local production units to send a particular request through the system that controls output. For example, if there was an unplanned shutdown and the operators want to know how to restart or if there will be issues to resolve, they can push a job into the system, which will take priority over existing jobs in the system work flow, and the system will automatically run predictions from the current situation, thereby providing guidance and further analysis for local engineers. This method 300 will significantly reduce lag time, and efficiently control the use of hydrodynamic models and flow assurance tools globally.

The process flow diagram of FIG. 3 is not intended to indicate that the steps of the method 300 are to be executed in any particular order, or that all of the steps of the method 300 are to be included in every case. Further, any number of additional steps not shown in FIG. 3 may be included within the method 300, depending on the details of the specific implementation.

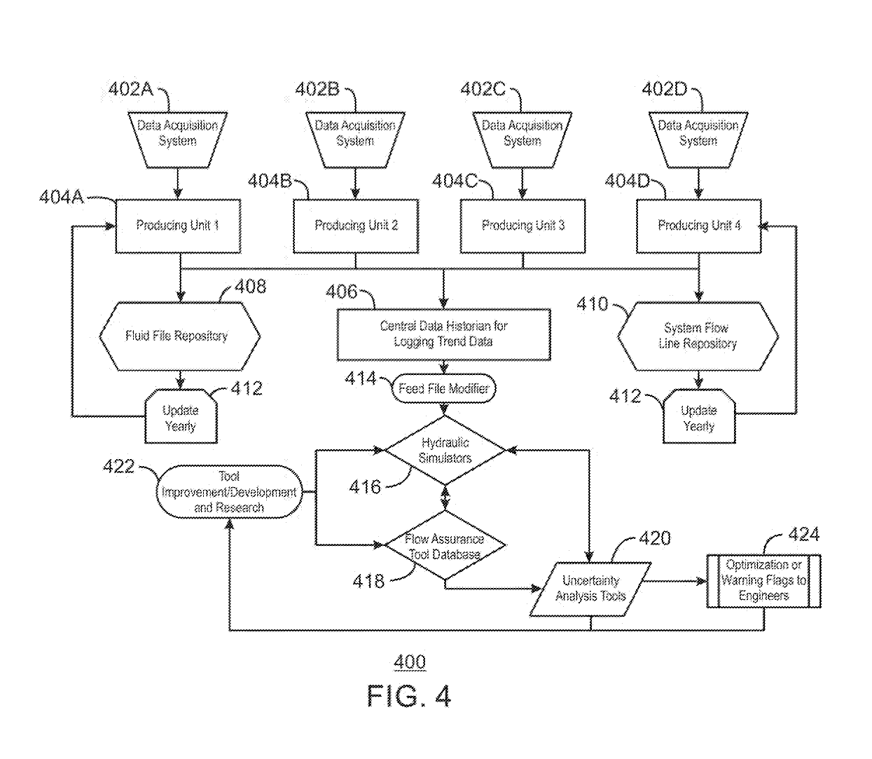

FIG. 4 is a schematic showing the flow assurance system 200 of FIG. 2 in greater detail. The schematic can include components such as, for example, sensors, software modules, hardware modules, plant equipment, and the like. The blocks can be multiple data acquisition systems 402A, 402B, 402C, and 402D are connected to multiple producing units 404A, 404B, 404C, and 404D. The multiple producing units 404A, 404B, 404C, and 404D may be adjacent or geographically dispersed. Each producing unit 404A, 404B, 404C, and 404D relays information through the data acquisition systems 402A, 402B, 402C, and 402D to a central data historian 406 used for logging trend data. The data acquisition systems 402A, 402B, 402C, and 402D can log information from measurement devices including but not limited to pressure transducers, flow meters, temperature probes, and level detectors, among others, configured to feed into a producing unit's respective data acquisition system. These measurements are stored as “tags” and can be analyzed locally to produce virtual tags. Once these measured tags are stored in a server, they are communicated to the central historian 406 database that collects the tag data from producing units 404 located, for example, around the world. These files are updated on a continual basis and can all be “housed” within the central pipeline data analysis tool for purposes of consistency and ease of access across organizational structures. This initial sequence of analyses provides the foundation for understanding conditions of a targeted flow line, and can be used to forecast any expected or anticipated changes that may or may not raise flow assurance concerns.

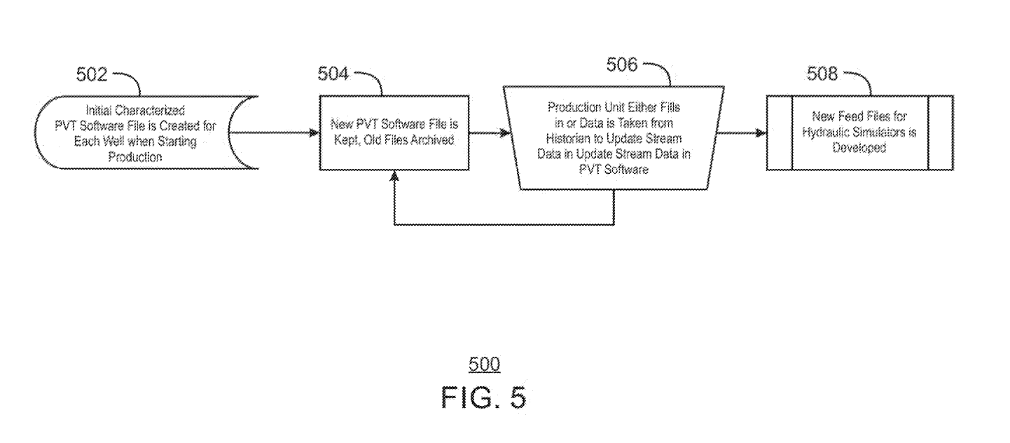

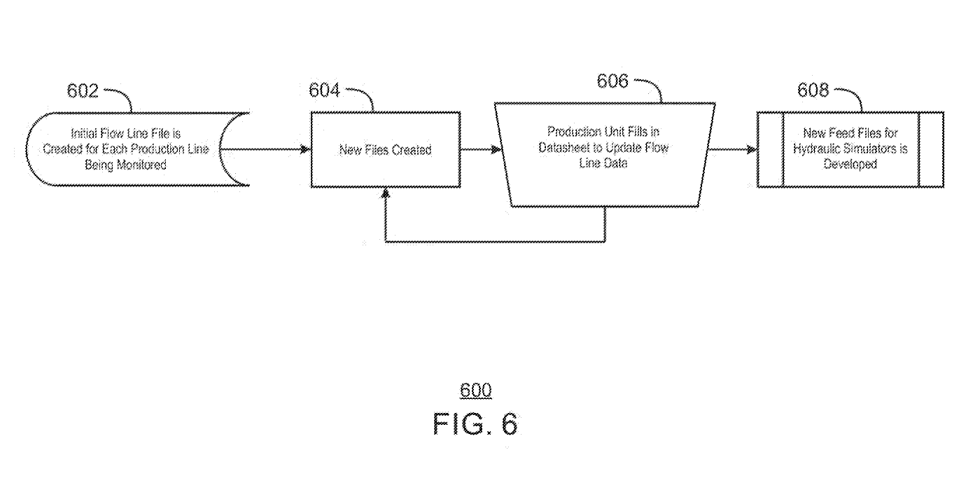

To properly analyze a system from a flow assurance standpoint, the values stored as tags may be continually managed and updated, accounting for changes in fluid conditions due to field aging, commingling of flow lines, lift gas additions, or other process changes. The updated profiles and fluid properties would then be sent to hydraulic simulators coupled with the desired flow assurance tools to predict pressure drops, temperature profiles, and flow rates, among other predictions. To that end, the hexagonal blocks 408 and 410 are dedicated to this issue of continually updating the pertinent system data. A fluid file repository 408, which is a central location where updated PVT files are maintained and located, and a system flow line repository 410, which is a central location where the field layout diagrams, piping diagrams, and well status are maintained, are connected to data acquisition systems 402, and are used to create the most accurate and up-to-date system base file information. The base file information can be updated periodically via an update module 412 over a regular interval. The fluid file repository 408 will be illustrated in more detail in FIG. 5, and the flow line repository 410 will be illustrated in more detail in FIG. 6. The data generated by these files are the base input for a subsequent feed file modifier 414.

With the most up to date fluid files and flow line conditions, the feed files for hydraulic simulators 416 can be created or updated, for example, by local field engineers, and subsequently run. The feed file modifier 414 is created to update the feed file, and the feed file is used as the basis for calculations made by the hydraulic simulators 416. The hydraulic simulators 416 will provide data on expected pressure drop profiles, temperatures, and flow conditions, for example, slugging or holdup potential, organic and inorganic scales, to name a few, that can be expected in the producing unit lines given the input feed file data. In an exemplary embodiment, the output of the hydraulic simulators 416 will be fed into the flow assurance tools database 418, and, based on the fluid file inputs, various models will be run to determine the propensity for developing issues that may adversely impact flow. Such issues impacting flow include, but are not limited to, formation of a fouling agent or material such as clathrate hydrates, waxes, asphaltenes, and so on, within the flow line, and the current proximity of the system to encountering issues that would hinder flow of a transported material.

In various examples, the flow assurance tools database 418 can include solids and chemical management tools, and can input variables to the hydraulic simulator models 416 due to combined effects of many flow assurance areas with hydraulic flow dynamics. For example, the formation of hydrates can change the flow regime, and sand concentration can change effective viscosity. The outputs from flow assurance tools database 418 will also be supplied to uncertainty analysis tools 420 to check that results are within accepted error boundaries. The final output will be used in tool improvement and future research and development 422 into more advanced hydraulic simulators and effective flow assurance models. If significant deviations are observed by the uncertainty analysis tools 420, then flags will be communicated to flow assurance engineers 424, indicating potential warnings that can be addressed or optimization opportunities that can be implemented.

After any discrepancies are flagged by previous data comparison techniques, the uncertainty analysis tools 420 will determine whether the discrepancy is statistically significant. Once flow assurance engineers analyze statistically significant changes within the system 400, updated data can be used with ongoing research programs to modify tools or processes. In some cases, a large discrepancy may be flagged that might be inherent to the models and not the actual system. Such a discrepancy will, for example, trigger modifications to the workflow, and stimulate further development efforts. The uncertainty tools 420 will allow engineers to adjust uncertainty criteria, based on desired parameters like fluid viscosity, for example, to help tune the hydraulic models to address field-specific situations. These adjustments then affect whether an analysis will trigger a flagging event, where personnel are alerted of potential warnings, or where a strategy for optimizing results can be implemented, based on current system performance and deviation from previously modeled data.

The schematic of FIG. 4 is not intended to indicate that the system 400 is to include all of the components shown in FIG. 4. Further, any number of additional components may be included within the system 400, depending on the details of the specific implementation. For example, different types of hydraulic simulators, flow assurance tools, and other chemical management tools and software can be included or omitted.

FIG. 5 is an exemplary method 500 of how conditions of a transported fluid can be monitored and updated over time, such as with respect to the fluid file repository 408 of FIG. 4. The fluid file repository 408 can include properties as diverse as fluid pressure, temperature and volume files stored in modeling software, laboratory data that is incorporated into the model, and fluid data sheets. Parameters including the presence of sand particles, increased viscosities, wax production, and hydrate formation curves can be accounted for, creating more accurate system models. The fluid file repository 408 is generally dedicated to housing a central database of fluid files and fluid data sheets for each producing well in a production system. These fluid files and data sheets include information to run hydraulic simulators, or models of a flow assurance tools database. In an exemplary embodiment, a fluid datasheet is periodically updated by the producing unit, and the appropriate changes will manifest in the pressure, volume, temperature (PVT) thermodynamic modeling software. In this example, a proprietary PVT software was used to model and update the appropriate thermodynamic variables.

The fluid file repository 408 begins analysis at block 502 with a characterization of the thermodynamic properties file that is created for each operating unit, such as well or pipeline, among others, at initial production. At block 504, a newer, updated thermodynamic properties file is kept while older files are archived locally. At block 506, the fluid file repository 408 is configured to have the production unit either automatically fill data into the analysis, or obtain configuration data from the local historian of FIG. 4, and update stream data accordingly. Once more, the updated file is kept while the older file is archived. The new feed file is finally developed at block 508 for hydraulic simulators, which will provide the most up to date information relating to fluid files and conditions within a feed line of a producing unit. These data can be used to assess system irregularities and areas of interest that may be problematic in the future. Personnel can be alerted of a possible course of action to troubleshoot problems or potential problems, assuring that flow is maintained. Such precautionary actions can be made using the techniques described herein before many problems would become apparent or even manifest in traditional pipeline systems.

The process flow diagram of FIG. 5 is not intended to indicate that the method is to include all of the steps or components shown in FIG. 5. Further, any number of additional steps or components may be included within the method, depending on the details of the specific implementation.

FIG. 6 is a process flow diagram of a method 600 for monitoring conditions related to a transportation structure, such as with respect to the flow line repository 410 of FIG. 4, which may house a central database of flow line details. Like the fluid file repository 408, the flow line repository 410 would house a current version of flow line geometries and physical conditions. In an exemplary embodiment, the fluid file repository 408 is configured to trigger periodic updates. This allows a production unit to make updates on properties that change with time. Such variables can be based from corrosion of the flow line and issues related to insulation and temperature regulation, to rapid erosion and wear of top side equipment including chokes, valves and flow lines, to whether any tie-in lines have been joined, or other changes are affecting the flow lines.

At block 602, an initial flow line file is created for each flow line from a production unit that is being monitored. At block 604, new files are created and stored locally. At block 606, the production unit fills in the data sheet and consequently updates data related to the flow line. This updated data is then sent back to block 604 as the new file that has been created. The process continues until the flow line repository 410 at block 608 develops an original feed file, which will be further modified and inputted into hydraulic simulators, used in conjunction with pipeline data analysis tools described herein. This feed file uses the most recently updated physical and thermodynamic properties related to the fluid and flow line. These updated data are then interpreted in order to flag areas of concern, and to indicate to personnel whether immediate action should be taken, or remedial measures should be implemented, in order to assure the continued flow of production fluid from a point of extraction to a subsequent point of sale.

The schematic of FIG. 6 is not intended to indicate that the method is to include all of the steps or components shown in FIG. 6. Further, any number of additional steps or components may be included within the method, depending on the details of the specific implementation.

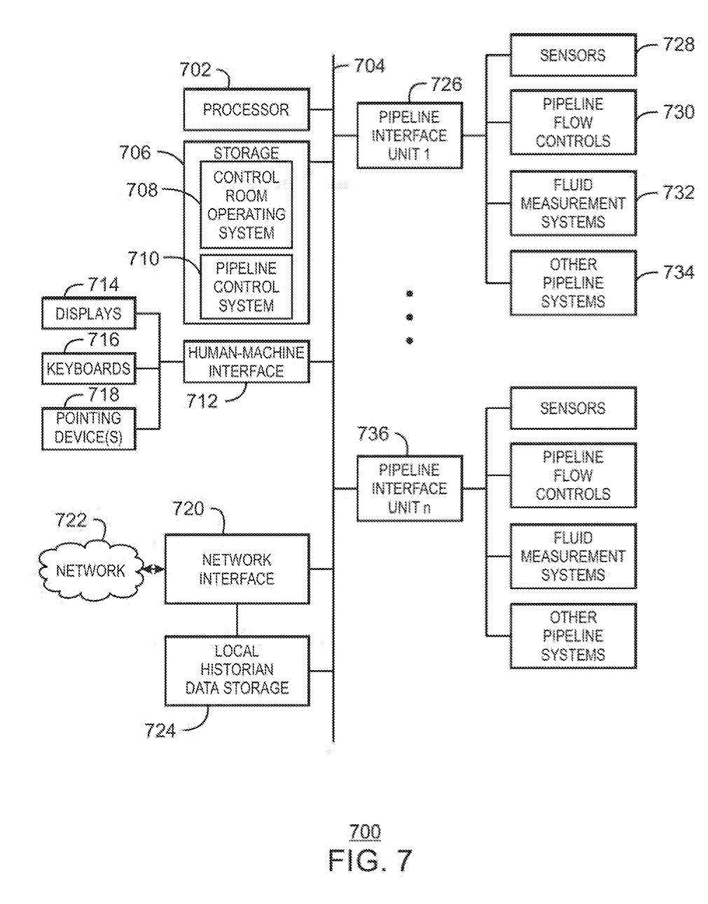

FIG. 7 is a schematic block diagram illustrating an exemplary control system 700 that may be used to implement flow assurance techniques. The control system 700 may relate to the control system 112 of FIG. 1, and may be part of a larger system, such as a distributed control system (DCS), a programmable logic controller (PLC), a direct digital controller (DDC), or any other appropriate control system. Further, the control system 700 may automatically adjust parameters, or may provide information about the separation system to an operator who manually inputs adjustments. Additionally, any controllers, controlled devices, or monitored systems, including measuring devices, sensors, valves, actuators, and other controls, may be part of a real-time distributed control network, such as a FIELDBUS system. In an exemplary embodiment, the control system 700 can be used to increase or decrease the flow rates of production fluids, adjust amounts of additives injected into lines, individually or as an ensemble, and alert engineers of conditions flagged as potential flow assurance issues.

The control system 700 may have a processor 702, which may be a single core processor, a multiple core processor, or a series of individual processors located in systems through the plant control system 700. The processor 702 can communicate with other systems, including distributed processors, in the plant control system 700 over a bus 704. The bus 704 may be an Ethernet bus, a FIELDBUS, or any number of other buses, including a proprietary bus from a control system vendor. A storage system 706 can be coupled to the bus 704, and may include any combination of non-transitory computer readable media, such as hard drives, optical drives, random access memory (RAM) drives, and memory, including RAM and read only memory (ROM). The storage system 706 can store code used to provide operating systems 708 for a pipeline control room, as well as code to implement pipeline control systems 710, for example, based on the systems and methods discussed above.

A human-machine interface 712 may provide operator access to the pipeline control system 710, for example, through displays 714, keyboards 716, and pointing devices 718 located at one or more control stations. A network interface 720 can provide access to a network 722, such as a local area network or wide area network for a corporation. A local historian 724 can also be connected to the network interface 720 and/or bus 704. In an exemplary embodiment, the local historian 724 archives and updates data files related to the pipeline and the transported fluid, and those data files are utilized in subsequent flow assurance analyses disclosed herein.

A pipeline interface for a first unit 726 may provide measurement and control systems for a first pipeline system. For example, the pipeline interface 726 may read a number of sensors 728, such as the measurement devices 106, 206 described with respect to FIGS. 1 and 2. The pipeline interface 726 may also make adjustments to a number of controls, including, for example, pipeline fluid flow controls 730 used to adjust the flow rate of particular flow lines throughout the pipeline system. The flow controls 730 can be used, for example, to adjust the actuator on a flow adjusting device or valve. The pipeline interface for a first unit 726 may exercise control based in part on indications made by fluid measurement systems 732, including phase level detectors, gas hydrate sensors, temperature, pressure and volume data, for example. The pipeline interface 726 can control other pipeline systems 734, including systems for injecting certain additives that help ensure flow rates of production fluids in the pipeline system are continuous.

This control system 700 can also be used by the local production units to send a particular request through the system. For example, if there was an unplanned shutdown and the operators want to know how to restart or if there will be potential issues, they can push a higher-priority job into the system, and the system 700 will automatically run the flow assurance predictions from the current situation to provide guidance for local engineers making the analyses. This will significantly reduce lag time and also control the use of hydrodynamic models and flow assurance tools globally. Another example includes a production unit that wants to bring on another well or commingle fluids. The fluid properties tools can be updated using the method 300 described with respect to FIG. 3, and the request for commingling fluid lines could be analyzed. The flow assurance system 200 of FIG. 2 can perform the analysis and flag any potential issues with commingling the fluids, including potential issues concerning scale, or the formation of asphaltenes, hydrates, wax, or other solid particles. Communication between the flow assurance system 200 and the corresponding control system 700 ensures that commands based on further analysis of fluid properties and flow lines are implemented when desirable.

It will be understood that the pipeline control system 700 shown in FIG. 7 has been simplified to assist in explaining various embodiments of the present techniques. The control system 700 is not limited to a single pipeline interface 726. If more flow lines are added, additional pipeline interfaces 736 may be included to control those new pipeline units, and to maintain an up-to-date global profile on the network 722 and network server (not shown). Further, the distribution of functionality is not limited to that shown in FIG. 7. Different arrangements could be used, for example, one pipeline interface system could operate several different measurement sections of pipeline and pipeline headers, while another pipeline interface system could operate controller systems, and yet another interface could operate other systems related to flow assurance within the pipeline. Accordingly, in embodiments of the present techniques numerous devices not shown or specifically mentioned can further be implemented. Such devices can include flow meters, such as orifice flow meters, mass flow meters, ultrasonic flow meters, and venturi flow meters, as an example. Additionally, compressors, tanks, heat exchangers, sensors, and sand traps can be utilized in further embodiments, separately or in addition to the units shown.

An exemplary use of the present techniques can be implemented when personnel would like to check if a certain production unit has capacity to produce more fluids in a flow line. The system is already indicating a database of pipelines calculated as under capacity based on information on flow rates, pressure drops, and the like, that are taken from local data measurements and stored in local servers which are pulled and stored on a global data historian. These potentially underperforming pipelines can be made more efficient using the disclosed techniques to pull the data, combined with up-to-date fluid files and flow line properties, to periodically generate new feed files into hydraulic simulators. If the flow lines are under capacity, flags are generated indicating that point. The output of the hydraulic models are then run into the flow assurance models that show, as an example, that drag reducing agents could enhance the capacity of flow lines. These flow lines are flagged, and that remedy may be suggested. Personnel would typically see that their flow lines are not annotated as “under capacity,” indicating they are currently at or above capacity. However, because of the fluid properties and flow line conditions that have now been measured and compared to updated data, the present system and method described herein has flagged the flow lines as good candidates to enhance capacity.

Another example of how the current techniques might be useful include using production fluids from a different reservoir into a subsea manifold that will be commingled in the flow line to downstream facilities. Using the techniques described herein, the fluid compositions of both proposed fluid streams may be submitted to flow assurance systems described herein and the PVT thermodynamic simulator package may generate three files: existing fluid, new fluid, commingled fluid streams with their respective properties. The current system and techniques would pull the flow line properties files with the new fluid files and generate a hydraulic feed file to be run in a number of hydraulic models. Before this happens, the present techniques first ensure that the initial model is consistent with current field measurements. If the hydraulic models predict issues with current conditions a flag will be issued giving the personnel warning on potential issues or to adjust the files/conditions as needed to match/tune to current field conditions. The commingled fluids are analyzed using techniques described herein, and the system determines if there are any issues per the constraints on the system. If issues arise, then a flag will be issued, for example, pressure drop is too high, slugging is occurring in the flow line, and the like. If no issue has been indicated, the outputs of the hydraulic simulator will be analyzed by a flow assurance tool package along with the fluid files. This is done to determine if, for example, any potential solids formation or incompatibilities exist, while taking into account inputs from the statistical analysis tool on uncertainties in the models.

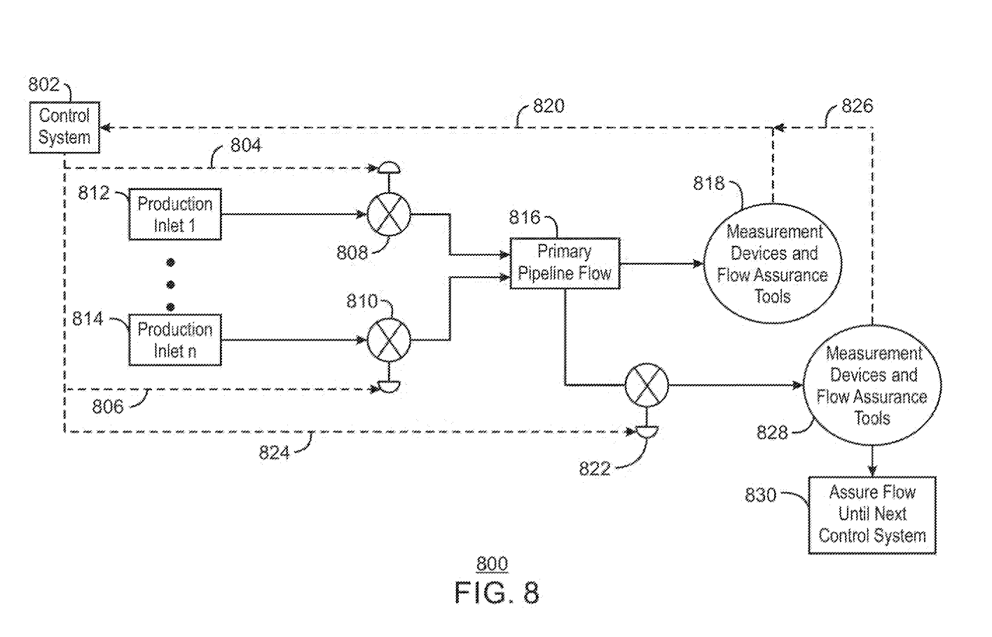

FIG. 8 is a schematic diagram of a pipeline system 800 that also illustrates a control system 802 operative to maintain the flow of fluid within the pipeline system 800 at a preferred rate based on certain measurements. The pipeline system 800 uses the control system 802 to send control signals 804 and 806 to each of the control valves 808 and 810 controlling the mass flow rate of a fluid transported within the pipeline system 800. The control system 802 may automatically adjust parameters, or may provide information about the pipeline system to an operator who manually inputs adjustments. The control system 802 is configured to send a control signal 804 to control valve 808 to control the flow from a particular production inlet 812, inlet 1. Similarly, a control signal 806 is sent to control valve 810, which can adjust the flow rate from a separate production inlet 814, inlet n, into a primary pipeline flow 816. It is to be understood that any number of separate production inlets may be incorporated within the current pipeline system 800. The flow rate of a particular production inlet 812, 814 can be controlled by control valves 808, 810.

The control valves 808 and 810 are configured to regulate the fluid velocity or mass flow rate within the primary pipeline flow 816. The measurement devices and flow assurance tools 818, for example, flow meters, temperature probes, and hydrate detecting sensors, to name a few, can be implemented within the primary pipeline flow 816, in a production inlet section 812 or 814, or both. A control signal 820 is generated based on input from the measurement devices and flow assurance tools, and is communicated to the control system 802, corresponding to measurements taken and indications made by the measurement devices and flow assurance tools 818. The control system 802 is configured to control the flow of production inlet 812, 814 into a primary pipeline flow 816.

The primary pipeline 816 can also incorporate a control valve 822 that is included to monitor and control the flow rate of the primary pipeline flow 816. This control valve 822 receives a control signal 824 from the control system 802, and the control valve 822 is configured to open or close according to the control signal 824 that is received. The control signal 824 output can be calculated based on control signal 820 inputs, discussed above, or based on control signal 826 from subsequent measurement devices and flow assurance tools 828 located downstream of control valve 822. Thus, the primary pipeline flow 816 is controlled by various control valves, 808, 810, and 822 communicating with a control system 802, that relies on signals sent from various measurement devices and flow assurance tools 818, 828. In this way, flow rate can be assured until the next control system 830, especially when potential problems are diagnosed before they arise, and required changes are made to the fluid flowing in the production lines, or to the lines themselves, so flow may be continually and efficiently maintained.

An example of using the flow assurance system can be illustrated using a hypothetical scenario. In the scenario, on an update, solids are reported from the fluid properties in a particular flow line, as determined by pigging. Further, during a periodic check on a particular project's pipelines, a pressure drop above the statistical uncertainty bounds, for example, a 20% uncertainty for general flow dynamics simulations, is detected after inputting updated fluid and flow line properties into the hydraulic simulators, and is compared to data logged in the historian. A flag is sent out, and the results are pushed into the flow assurance tools for analysis. Based on the analysis it is determined that the fluids do not fall into hydrate formation conditions, but the analysis of the fluids being transported determines they are below the wax appearance temperature. After running the flow assurance programs, the issues of wax deposition and sand settling remain a concern that can potentially hinder continuous flow. These issues are flagged and a report is sent to personnel for analysis. Upon further investigation it is found that the flow lines had not been pigged after the last runs due to finding the solids and fear of blocking the lines. An extended team can then be formed to develop a low risk solution to fix the issues and adjust the flow assurance management plan accordingly.

This pipeline system 800 can also be used by the local production units to send a particular request through the system. For example, if there was an unplanned shutdown and the operators want to know how to restart or if there will be potential issues, they can push a job into the system that will take priority over existing jobs, and the system will automatically run the predictions from the current situation. The predictions made by the pipeline system 800 provide guidance to local engineers to analyze. This will significantly reduce lag time and also control the use of hydrodynamic models and flow assurance tools globally.

It will be understood that the pipeline system 800 shown in FIG. 8 has been simplified to assist in explaining various embodiments of the present techniques. Accordingly, in embodiments of the present techniques numerous devices not shown or specifically mentioned can further be implemented. Such devices can include flow meters, such as orifice flow meters, mass flow meters, ultrasonic flow meters, venturi flow meters, and the like. Further, compressors, tanks, heat exchangers, and sensors can optionally be utilized in embodiments in addition to the units shown.

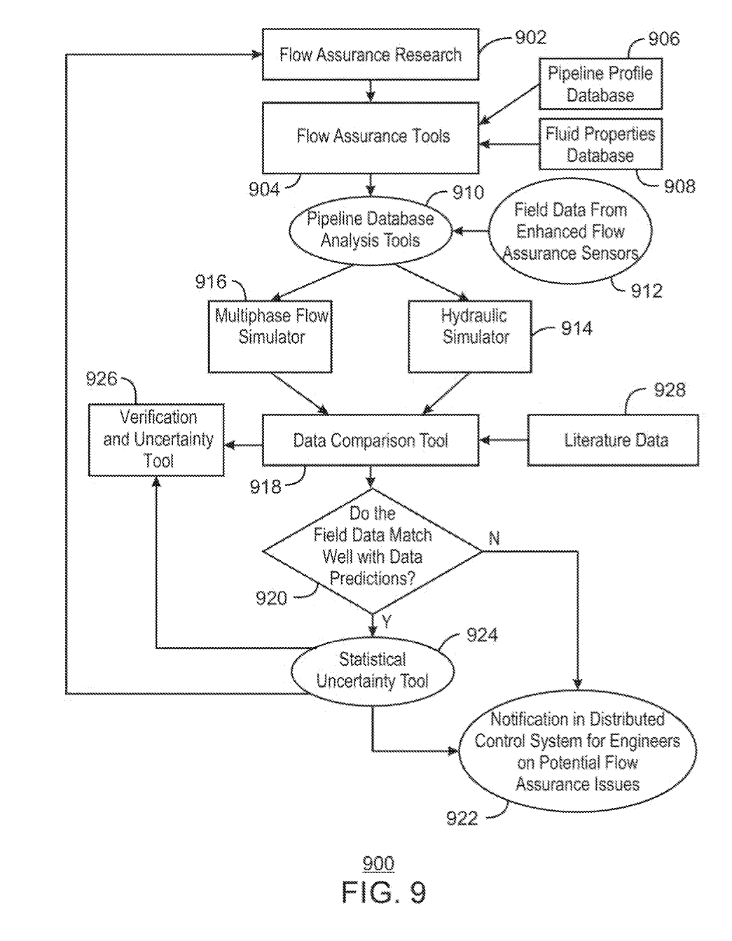

FIG. 9 is another schematic illustrating a comprehensive work flow in which global field data can be monitored and engineers may be notified if potential flow assurance issues are detected. At the outset, the system 900 would perform flow assurance research at block 902. The research can be based on discrepancies in the process, as well as finding areas were uncertainty is high in order to understand underlying reasoning, and how to adjust the tools to account for high uncertainty areas. Flow assurance tools 904 can be used to model such variables as sand formation, hydrate formation, wax and solids formation, drag reduction agent use and effectiveness, for example. These data are more accurately modeled by utilizing inputs from both a pipeline profile database 906, as well as a fluid properties database 908. The pipeline profile database 906 stores an updated version of the particular flow line geometry or changes in geometry, and physical condition of the flow line and changes in physical condition. Periodic updates can use data stored in the pipeline profile database 906 to ensure the most accurate variable are used in subsequent flow assurance tools and model simulators. The fluid properties database 908 stores and supplies data related to variables such as fluid pressure, temperature and volume files stored in modeling software, laboratory data that is incorporated into the model, as well as fluid data sheets, for example. Parameters including the presence of solid particles like sand, increased viscosities, wax production, and hydrate formation curves can be accounted for in the fluid properties database 908, thereby creating more accurate system models that can be updated periodically. Inputs for each database 906, 908 can be updated and reconfigured based on changes within the transportation system, for example, a production pipeline.

A global Pipeline Data Analysis Tool (PDAT) 910 can be configured to input desired field data 912 obtained from enhanced flow assurance sensors on a predetermined interval for various fields in the portfolio. Data tags can be coupled with the respective pipeline profile and fluid property data, such as those generated by PVT software. These files would also be updated on a continual basis and would be “housed” within the central PDAT 910 for consistency. The updated profiles and fluid properties would then be sent to hydraulic simulators 914 coupled with the desired flow assurance tools 904 to predict pressure drops, temperature profiles, and flow rates, for example. The updated profiles and fluid properties may alternately or additionally be sent to a multiphase flow simulator 916 to predict the characteristics of the multiphase flow. These updated outputs can then be fed to the data comparison tool 918 for understanding the uncertainty in the particular analysis and then compared to the data from the field. A determination is made at 920 to see whether the field data 912 are consistent with the model predictions. If the data from the field 912 are matching well with the predictions, the cycle continues. However, if there is a large discrepancy, for example, 20% for general hydraulic simulations determined from current field validation efforts, with the prediction beyond the uncertainty given by the data comparison tool, then a notification will be sent to the desired personnel 922 for further analysis and perhaps actionable steps to be proactive in preventing escalation of the particular flow assurance issue.

If the field data 912 are seemingly in agreement with the simulator predictions, the information will be input into the statistical uncertainty tool 924 that is configured to analyze the most important factors affecting the predictions and thus the uncertainty in the calculation. This data can be fed into a verification and improvement tool 926 for updating the base hydrodynamic model if needed. The data can also be fed to the flow assurance research block 902 to update/research the models in flow assurance tools 904, and the comprehensive workflow begins again. At any time, data from various sources, such as literature data 928, can be inputted into the data comparison tool for more accurate system modeling and simulator calculations.

The schematic of FIG. 9 is not intended to indicate that the system is to include all of the components shown in FIG. 9. Further, any number of additional components may be included within the system, depending on the details of the specific implementation.

In summary, embodiments of the present techniques may relate to a method for long-term flow assurance in a transportation system. The method may periodically acquire and store data related to a transported material and transportation structure in the transportation system. Additionally, the method may analyze the data at a first time via flow assurance tools to generate a first analysis, and communicate and store the first analysis to a central location. The method may analyze the data at a second time via the flow assurance tools to update the first analysis to generate a second analysis, the second time later than the first time, and compare the first analysis and the second analysis to determine a flow assurance issue. In some examples, the method may include alerting personnel of the flow assurance issue. The flow assurance issue may be a prediction of problematic flow conditions of the transported material in the transportation structure. The flow assurance issue may also be an opportunity to increase the flow rate of the transported material through the transportation structure. Further, the transportation structure may include a pipeline, and the transported material may include hydrocarbons, for example, crude oil, natural gas, or some other hydrocarbon.

Some embodiments of the present techniques also provide that a flow assurance issue can be a recommended change to flow assurance workflow. In some embodiments, the periodic acquisition of data can include measuring a physical property of the transported material in the transportation structure. In other embodiments, periodically acquiring data includes acquiring data from the transportation structure at a field site. In some embodiments, physically storing the data includes updating a fluid properties file associated with the transported material, and updating a system properties file associated with the transportation structure. The flow assurance tools can include a hydraulic simulator, and analyzing the data can include generating a feed file for the hydraulic simulator. In some embodiments, analyzing the data can also include, but is not limited to, implementing statistical analysis tools.

Some embodiments of the techniques described herein also provide a method of production of oil and gas, including periodically acquiring and storing data related to a pipeline transporting the oil and gas. The method can include analyzing the data at a first time via flow assurance tools to generate a first analysis, and communicating and storing the first analysis to a central location. The method can include analyzing the data at a second time via the flow assurance tools to update the first analysis to generate a second analysis, the second time later than the first time, and comparing the first analysis and the second analysis to determine a flow assurance issue of the oil and gas through the pipeline. The method can include flagging personnel of a flow assurance issue that has been determined. The method can also include taking preventative measures to solve or optimize a flow assurance issue that has been determined.

Some embodiments of the techniques described herein also provide a transportation system including a transportation structure configured to convey a transported material. A measurement device can be coupled to the transportation structure and configured to acquire data related to the transportation structure and transported material. A control system can also be configured to analyze the data at a first time via flow assurance tools to generate a first analysis. The control system can analyze the data at a second time via the flow assurance tools to update the first analysis to generate a second analysis, the second time later than the first time. The control system can compare the first analysis and the second analysis to determine a flow assurance issue. In some embodiments, the transported material includes hydrocarbons and the transportation structure includes a pipeline. In some embodiments, the control system includes a pressure, volume, and temperature thermodynamic simulator configured to update over time based on data acquired by the measurement device. In some embodiments, the control system includes a flow assurance prediction tool to flag personnel on potential issues or optimizations in the transportation system. The flow assurance prediction tool can be configured to update a flow assurance curve. The flow assurance prediction tool can be configured to update a feed file for a simulator. The feed file can related to the transported material. The feed file can be related to a system file associated with the transportation structure.

While the present techniques may be susceptible to various modifications and alternative forms, the embodiments discussed above have been shown only by way of example. However, it should again be understood that the techniques are not intended to be limited to the particular embodiments disclosed herein. Indeed, the present techniques include all alternatives, modifications, and equivalents falling within the true spirit and scope of the appended claims.

What is claimed is:

1. A method for long-term flow assurance, comprising:
periodically acquiring data from multiple transportation systems each having a transportation structure and a transported material;
storing the data in a central location;
maintaining a global predictive flow model based on the data acquired from the multiple transportation systems; and
analyzing via the global predictive flow model a data set of a transportation system of the multiple transportation systems to determine a flow assurance issue of the transportation system.

2. The method of claim 1, wherein at least some of the multiple transportation systems are geographically dispersed with respect to one another.

3. The method of claim 1 or of claim 2, wherein each transportation structure comprises a pipeline, and the respective transported material comprises hydrocarbons.

4. The method of claim 1 or of any of claims 2-3, wherein periodically acquiring data comprises measuring a physical property of the transported material in each transportation structure, respectively, of the multiple transportation systems.

5. The method of claim 1 or of any of claims 2-4, wherein periodically acquiring data comprises acquiring field-site data related to each respective transportation structure of the multiple transportation systems.

6. The method of claim 1 or of any of claims 2-5, wherein maintaining the global predictive flow model comprises updating a fluid properties file associated with transported material.

7. The method of claim 1 or of any of claims 2-6, wherein maintaining the global predictive flow model comprises updating a system properties file associated with transportation structure.

8. The method of claim 1 or of any of claims 2-7, wherein the global predictive flow model comprises a hydraulic simulator.

9. The method of claim 8, wherein maintaining the global predictive flow model comprises generating a feed file for the hydraulic simulator.

10. The method of claim 1 or of any of claims 2-9, comprising:
anticipating a change to one or more of the transportation structures of any of the multiple transportation systems, wherein the flow assurance issue is a forecasted flow assurance issue raised by the change; and
making the change based on the analysis.

11. The method of claim 1 or of any of claims 2-10, wherein the data set analyzed comprises monitored data acquired from the transportation system, and wherein the data set is related to the transportation structure and the transported material of the transportation system.

12. The method of claim 1 or of any of claims 2-11, wherein the data set analyzed comprises data provided by operating personnel in an effort to evaluate the transportation system, and wherein the data set is related to the transportation structure and the transported material of the transportation system.

13. The method of claim 1 or of any of claims 2-12, comprising alerting personnel of the flow assurance issue.

14. The method of claim 1 or of any of claims 2-13, wherein the flow assurance issue comprises a prediction of problematic flow of the transported material in the transportation structure of the transportation system.

15. The method of claim 1 or of any of claims 2-14, wherein the flow assurance issue comprises reduced flow, slug flow, holdup potential, organic and inorganic scales, sand concentration, formation of hydrates, formation of waxes, or formation of asphaltenes, or any combination thereof.

16. The method of claim 1 or of any of claims 2-15, wherein the flow assurance issue comprises an opportunity to increase a flow rate of the transported material through the transportation structure of the transportation system.

17. The method of claim 1 or of any of claims 2-16, wherein the flow assurance issue comprises a recommended change to flow-assurance workflow.

18. A method of producing oil and gas, comprising:
acquiring first data related to a first pipeline transporting oil and gas;
acquiring second data related to a second pipeline transporting oil and gas;
storing the first data and the second data in a central location;
constructing a global predictive flow model correlative with the first data and the second data; and
comparing subsequent data related to the first pipeline to the first data via the global predictive flow model to determine a flow assurance issue of the first pipeline.

19. The method of claim 18, comprising flagging personnel of the flow assurance issue.

20. The method of claim 18 or of claim 19, comprising taking preventative measures to resolve the flow assurance issue, or taking measures to advance the flow assurance issue.

21. A flow assurance system comprising:
a central database to store data acquired from multiple transportation systems that each convey a respective transported material comprising hydrocarbons; and
a global server configured to:
acquire the data from the multiple transportation systems and store the data to the central database;
maintain a global predictive flow model correlative with the data acquired from the multiple transportation systems; and
analyze via the global predictive flow model a data set of a transportation system of the multiple transportation systems to determine a flow assurance issue of the transportation system.

22. The system of claim 21, wherein at least some of the multiple transportation systems are geographically dispersed with respect to one another.

23. The system of claim 21 or of claim 22, comprising respective measurement systems in the multiple transportation systems, the measurement systems configured to facilitate acquisition of the data.

24. The system of claim 21 or of claims 22-23, wherein the global predictive flow model comprises a hydraulic simulator, and wherein maintaining the global predictive flow model comprises generating a feed file for the hydraulic simulator.

25. The system of claim 21 or any of claims 22-24, wherein the global predictive flow model comprises a pressure, volume, and temperature thermodynamic simulator configured to update over time based on the data acquired.

26. The system of claim 21 or any of claims 22-25, wherein each transportation system comprises a pipeline, and wherein maintaining the global predictive flow model comprises updating a fluid properties file associated with the respective transported materials, updating a system properties file associated with structure of the respective pipelines, or a combination thereof.

27. The system of claim 21 or any of claims 22-26, wherein the data set analyzed is related to a pipeline of the transportation system and to the hydrocarbons conveyed by the transportation system.

28. The system of claim 21 or of any of claims 22-27, wherein the flow assurance issue comprises a prediction of problematic flow of the hydrocarbons in the transportation system.

29. The system of claim 21 or of any of claims 22-28, wherein the flow assurance issue comprises reduced flow, slug flow, holdup potential, organic and inorganic scales, sand concentration, formation of hydrates, formation of waxes, or formation of asphaltenes, or any combination thereof.

30. The system of claim 21 or of any of claims 22-29, wherein the flow assurance issue comprises an opportunity to increase a flow rate of the transported material.
